(19) United States
(12) Patent Application Publication
(10) Pub. No.: US 2017/0017763 A1
(43) Pub. Date: Jan. 19, 2017

(54) SYSTEMS AND METHODS FOR ASSISTING PEOPLE WITH A PHYSICAL, MENTAL OR EMOTIONAL IMPAIRMENT

(71) Applicant: Peter G. Zimmer, Halifax (CA)

(72) Inventor: Peter G. Zimmer, Halifax (CA)

(21) Appl. No.: 14/800,602

(22) Filed: Jul. 15, 2015

(51) Int. Cl. G06F 19/00; G06F 3/0484; G06F 3/0482; H04L 29/08

(52) U.S. Cl. CPC G06F 19/3406; H04L 67/025; G06F 3/04847; G06F 3/0482; G06F 3/04842

(57) ABSTRACT

A method of assisting a care recipient in operating a first device, includes providing a care recipient interface configured to be installed on a second device, such that the care recipient can use the second device to operate the first device, and providing a caregiver interface configured to be installed on a third device and configurable to remotely program the care recipient interface to present a custom-selected image to facilitate the care recipient operating the first device.

### FIELD

The field of the inventive subject matter discussed herein is assistive devices for physically, mentally or emotionally impaired persons.

### BACKGROUND

The background description includes information that may be useful in understanding the presently disclosed subject matter. It is not an admission that any of the information provided herein is prior art or relevant to the presently disclosed subject matter, or that any publication specifically or implicitly referenced is prior art.

There are many individuals that suffer from a physical, mental or emotional impairment. Depending on the level of impairment, some individuals can have substantial difficulties operating appliances and other commonly used devices. For example, Alzheimer's disease can cause substantial cognitive impairment of an individual to the extent that simple appliances, such as a telephone or radio are impossible to operate. In addition, individuals often experience frustration, stress or anger caused by the inability to operate the appliance or other commonly used device.

Some have attempted to simplify appliances and other commonly used devices to accommodate individuals suffering from at least one of a physical, mental or emotional impairment. For example, Amick (U.S. Patent Pub. No. 2007/0222772) discloses the use of images on a device that correspond to control settings of the device for users with diminished mental capacity. In one embodiment, Amick describes a telephone having images of relatives, such that a user can locate the image of the person of interest and touch the image to place a phone call. In another example, Bolas (U.S. Pat. No. 6,389,463) discloses a device resembling a typical radio receiver that is connected to a computer to receive streaming audio or other audio sources. The receiver has a volume selector, a band selector (for selecting amongst FM, AM, or internet bands), and a tuning knob. Users can tune amongst various internet music stations using knobs rather than interacting with a computer to play music the various internet music stations. Other devices that can assist an individual suffering from at least one of a physical, mental or emotional impairment are discussed in Fotuhi (U.S. Pat. Pub. No. 2009/0033472) and Jasinschi (WO Publication No. 2012/164534). While these devices improve the ability to aid some individuals suffering from at least one of a physical, mental or emotional impairment, these devices may be too modern and confusing for some individuals.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need in the art for a device that can be tailored to meet the needs of a specific user suffering from at least one of a physical, mental or emotional impairment.

### SUMMARY

The present disclosed subject matter provides apparatus, systems, and methods in which a first device is at least partially controlled by a second device operated by a care recipient, which is in turn programmable by a third device operated by a caregiver.

As used herein, the term “care recipient” means a person (whether alone or as part of a group) who is under the at least partial care or control of another person or entity (the “caregiver”). There are two general categories of care recipients, (i) individuals having a physical, mental or emotional impairment, and (ii) individuals who are not impaired, but over whom a caregiver has at least partial control with respect to a device (e.g., a first device). The first general category of care recipients includes, for example, Alzheimer's or other patients in an assisted living home, and the second general category includes, for example, hotel guests, and children in a school.

According to aspects of the present inventive subject matter, a care recipient typically uses a care recipient interface on a second device to operate a first device. As used herein, the first device is any device that is configured to be electronically controlled. Preferably, first devices include lights and electronics floor lamps and other lights, security units, telephones, radios, televisions, intercom system, heating and air conditioning units, smoke alarms, computers, and other devices that can be electronically controlled that use energy from at least one of electric grid, gas grid, water, wind and solar. However, in other embodiments the care recipient interface can be installed on the device that it is configured to operate. For example, a special radio device is a radio having all the necessary components of a radio and that further includes a care recipient interface in a single unit so that two devices are not needed for care recipient to operate a device using the care recipient interface.

In one aspect of the inventive subject matter, the third device programs the second device to present a custom-selected image to the care recipient, which image facilitates the care recipient's operation of a first device. For example, where the first device is a thermostat, the custom-selected image might be selected to make the second device appear to the care recipient as an old-fashioned thermostat. This could be particularly useful where the care recipient has Alzheimer's disease, and is more comfortable with an old-fashioned thermostat than a more modern thermostat. In the case of a phone, selected images could be of people, (e.g., relatives, doctors, caregivers), of buildings (e.g., current or past homes, work places), etc. In the case of a radio, selected images could be of a musician or musical group, an icon suggestive of a genre, or perhaps an image of a building in a town with which the care recipient has particular memory association.

The care recipient can interact with the second device in any suitable manner. For example, the care recipient can interact with the second device using a knob, slider, push-pull mechanism, button, switch, touch-screen display, bulb or some other device suitable to receive a physical interaction (e.g., touch, push, pull, squeeze, flip, slide, rotation, etc.). Suitable physical interactions include, but are not limited to, pushing a button, pulling a knob, rotating a knob, touching a touch-screen display, sliding a slider, pushing or pulling on a push-pull mechanism, flipping a switch, squeezing a bulb, and any other physical action with any input device. Additionally or alternatively, the care recipient can interact with the second device using verbal or other auditory interactions (e.g., music, sound, or voice recognition. Still further, the care recipient could interact with the second device at least in part using a hand gesture, eye movement, or other visible but not tactile signal.

Contemplated first devices that can be controlled using the inventive subject matter include one-way communication devices (e.g., radios and televisions), two-way communication devices (e.g., telephones and intercoms), alarms (e.g., smoke or gas detectors, security alarms), and environment controls (e.g., thermostats, water faucet temperature control, lighting controls).

A wide variety of devices can be operated by the care recipient as the second device, including general purpose electronics, including for example iPad's® or other tablets, computers, and mobile phones. In such cases, for example, an iPad® could be configured to display an image of a thermostat, or a telephone, which the care recipient could operate by touching the display screen.

Also contemplated are specially designed second devices, which physically mimic the first device that is being controlled. For example, a boxy housing could be configured to look like an old-fashioned radio, with a knob that operates a sliding needle. It is contemplated that in other embodiments, the specially designed devices have the typical components of the device that it mimics. For example, a specially designed telephone is a telephone that includes a care recipient interface that enables the care recipient to operate the telephone.

In both instances, where the second device is a general purpose electronic device or a specially designed device, at least a portion of the care recipient interface operated by the care recipient can be selected or otherwise programmed by the caregiver. Preferably, the care recipient interface can be selected or otherwise programmed to include an image that is readily recognizable by the care recipient to facilitate the care recipient's use of the second device, which in turn at least partially controls a first device.

Using the third device, the caregiver can interact with the second device in ways other than merely selecting an image. For example, the third device could be used to remotely program the second device to (i) operate one or more first devices, (ii) set defaults for each of the first devices; (iii) override or limit a temperature, volume, or other setting that had been selected by the care recipient, and/or (iii) send and receive alerts based on a current setting for one of the first devices.

One should appreciate that the disclosed subject matter provides many advantageous technical effects, including facilitating individuals' indirect operation of devices using interfaces for which they have historic familiarity, while also providing oversight to such operation by a caregiver.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A is a general embodiment, showing the interchange between a caregiver device, a care recipient device, and a first device.

FIG. 1B is another general embodiment, showing the interchange between a single caregiver device, two care recipient devices, and first and fourth devices.

FIG. 2 is an embodiment of a general system block diagram.

FIG. 3 shows an embodiment of a care recipient user interface on a second device.

FIG. 4 shows an embodiment of a caregiver user interface on a third device.

FIG. 5A shows an embodiment of a specialized thermostat device having a thermostat-like control image and a knob.

FIG. 5B is a side view of the specialized thermostat device of FIG. 5A.

FIG. 6 shows another embodiment of a specialized thermostat device having a thermostat-like control image and a knob.

FIG. 7A shows an embodiment of a specialized thermostat device having a thermostat-like control image, specifically in an off mode.

FIG. 7B shows the specialized thermostat device of FIG. 7A in an on mode.

FIG. 7C shows the specialized thermostat device of FIG. 7A in a warming mode.

FIG. 7D shows the specialized thermostat device of FIG. 7A in a cooling mode.

FIG. 7E shows the specialized thermostat device of FIG. 7A in a state in which service or additional monitoring may be desired.

FIG. 7F shows the specialized thermostat device of FIG. 7A presenting a second thermostat-like control image.

FIG. 8 shows a specialized radio device having a care recipient interface.

FIG. 9 shows an embodiment of a caregiver user interface for limiting/overriding care recipient controls and confirming alarm settings.

FIG. 10 shows an embodiment of a phone interface for a care recipient, in which a caregiver has incorporated customized images.

FIG. 11 shows an embodiment of a device selection user interface for a care recipient.

FIG. 12 shows an embodiment of a status screen for a caregiver to monitor a care recipient.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Care recipients can be assisted to operate a first device by using a care recipient interface that is remotely programmable by a caregiver. Typically, the care recipient interface is installed on a second device, such as a mobile phone, a tablet or a computer. The caregiver can use a caregiver interface installed on a third device to monitor and operate first and second devices, and remotely program a custom-selected image on the care recipient interface to facilitate operating the first device. It is contemplated that the second device is a specially designed device that mimics the physical appearance of the first device and/or is configured to perform at least some functions of the first device. For example, second device can be a special radio device that is a radio and includes a care recipient interface. In such example, the first and second devices are combined in a single unit. The custom-selected image is typically an image that is recognizable to the care recipient that facilitates operation of the first device. Thus, it should be appreciated that the systems and methods disclosed herein can facilitate individuals' indirect operation of devices using interfaces for which they have historic familiarity, while also providing oversight to such operation by a caregiver

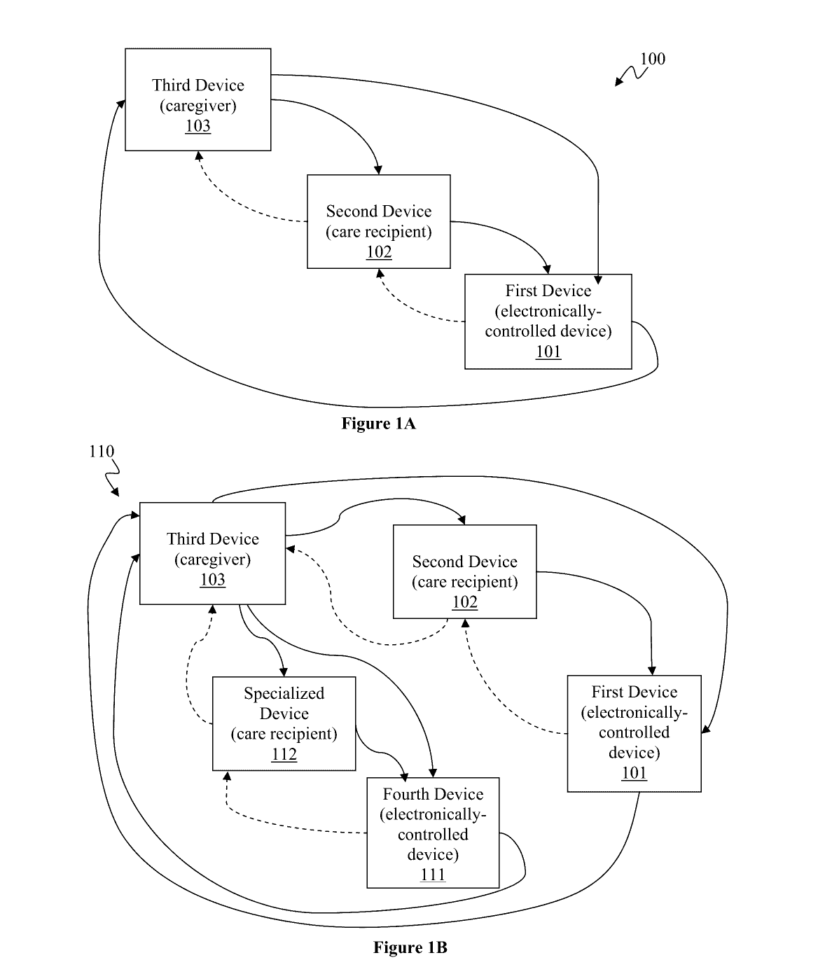

FIG. 1A is a general embodiment, showing the interchange between a first device 101, a second device 102, and a third device 103. First device 101 comprises an electrically-controllable device or an appliance. Envisioned representative devices include radios, televisions and other media devices, telephones and facsimile machines and other communication devices, smoke alarms and carbon monoxide detectors and other warning and security systems, heating ventilation and air conditioning (HVAC) systems, air conditioning units, fans, fireplaces, and other temperature-control systems, among others.

First device 101 may be controlled directly or indirectly by a second device 102 and a third device 103. Second device 102 may be a general computer, tablet, laptop, mobile phone or other portable computing device, or may be a specialized device. In a specialized device form, second device 102 could comprise one or more physical control mechanisms and a digital display, configured to take on the appearance of a traditional appliance or device control interface. Although second device 102 may also be operated by a caregiver or third party, either directly or in some instances remotely, second device 102 is primarily operated by a care recipient.

Third device 103 may be operated by a caregiver or third party, either directly or in some instances remotely, but will primarily be operated by a caregiver. Third device 103 controls the range of settings visible to a viewer or user of the second device 102 and thus is able to control certain settings on first device 101. In some instances, it may be desired for first device 101 to give feedback to second device 102, and for second device 102 to give feedback to third device 103. In other instances, for first device 101 gives feedback to third device 103, using, for example real-time or time-delayed status updates, may be sufficient.

Although FIG. 1A shows one of each of first device 101, second device 102, and third device 103, it is conceived that the needs of a care recipient may dictate that a single caregiver device interact with a plurality of care recipient devices and a plurality of appliances or electrically-controllable devices. For example, a single care recipient may desire to control multiple appliances or electrically-controllable devices with a single device. Alternatively, a single care recipient may desire to control one or more appliances with a more tactile specialized device that mimics the interface of a traditional device, and other devices with a digital screen device. In other situations, a single caregiver may be overseeing the interactions of multiple care recipients who may or may not each be controlling multiple devices themselves. It is foreseen that this system is fully customizable and configurable to accommodate such scenarios and still others.

Thus, in alternate embodiments one or more caregiver device(s) may interface with one or more care recipient device(s) and one or more appliance/electrically-controllable device(s), depending on the needs of the care recipient and the caregiver. One such example embodiment is depicted in FIG. 1B, where a third device 103 (e.g., caregiver device) is configured to oversee operations by a second device 102 (e.g., a care recipient device) and a first device 101, as well as a specialized device 112 and a fourth device 111. First device 101 is an appliance or other electrically-controllable device, as discussed above. Fourth device 111 is another appliance or electrically-controllable device.

As discussed above, first device 101 may be controlled directly or indirectly by a second device 102 and a third device 103. Fourth device 111 may be controlled directly or indirectly by a specialized device 112 and third device 103. Specialized device 112 comprises one or more physical control mechanisms and a digital display. Second device 102 and specialized device 112 may also be operated by a caregiver or third party, either directly or in some instances remotely, but will primarily be operated by a care recipient. Third device 103 may be operated by a caregiver or third party, either directly or in some instances remotely, but will primarily be operated by a caregiver. Third device 103 not only controls the range of settings that second device 102 sees and is able to control, which in turn controls settings on first device 101, but also controls the range of settings that specialized device 112 sees and is able to control, which in turn controls settings on fourth device 104. In some instances, it may be desired for first device 101 and fourth device 111 to give feedback to their controlling devices, second device 102 and specialized device 112, respectively, and for second device 102 and specialized device 112 to give feedback to third device 103. In other instances, for first device 101 and fourth device 111 gives feedback to third device 103, via real-time or time-delayed status updates, may be sufficient.

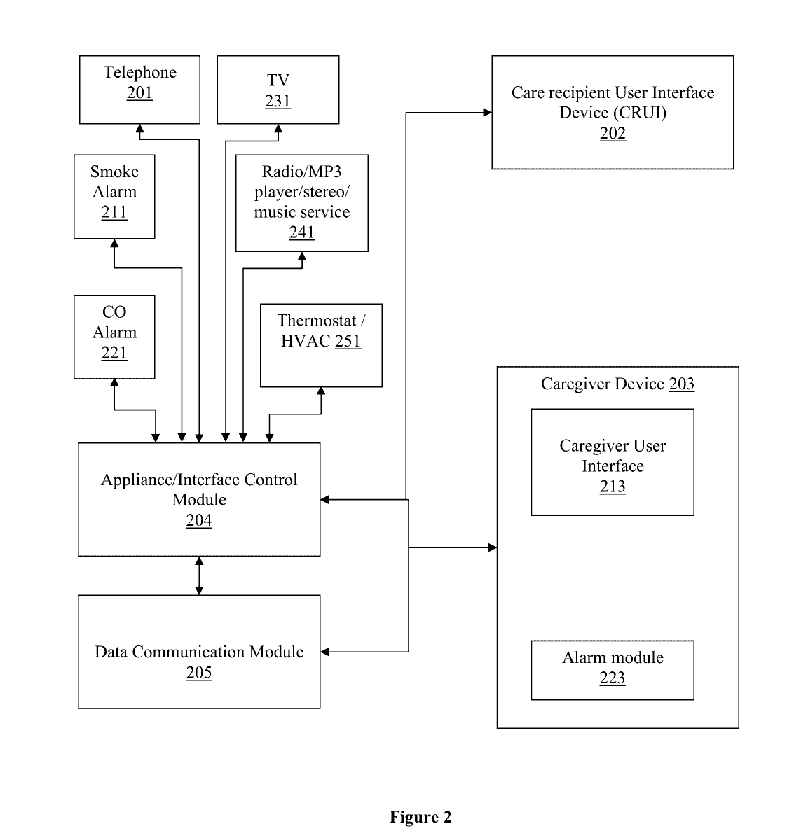

FIG. 2 is a general system block diagram of an example system of the disclosed subject matter. Six devices have been configured to utilize the system: telephone 201, television (TV) 231, radio/MP3 player/stereo/music service 241, smoke detector/alarm 211, carbon monoxide detector/alarm 221, and thermostat/HVAC system 251. The care recipient may use a device such as a care recipient user interface device (CRUZ) 202 to control the configured at least one of telephone 201, television (TV) 231, radio/MP3 player/stereo/music service 241, smoke detector/alarm 211, carbon monoxide detector/alarm 221, and thermostat/HVAC system 251. In reality, the CRUI's commands are routed through an appliance/interface control module 204, unbeknownst to the care recipient, with the data communication module 205 coordinating the data communication modes, such as Bluetooth, Wi-Fi over a LAN or WAN, etc. Similarly, the caregiver device 203, through the caregiver user interface 213, interacts with the appliance/interface control module 204 and data communication module 205 to limit the settings and range of control by the care recipient of the configured appliances/devices. Thus, the care recipient can control all of the configured devices easily, and in a manner familiar to them, without setting the temperature or other settings in a way that could be harmful to their health or impacted by their condition.

Although smoke detector/alarm 211 and carbon monoxide detector/alarm 221 are also configured devices, it may generally not be desired for a care recipient to have access to powering such devices. Thus, control of such alarmed devices is most likely to be done through the caregiver user interface 213, and in conjunction with the alarm module 223 of the caregiver device 203. The alarm module 223 may comprise a variety of settings to aid notification of caregivers, medical professionals, and other emergency professionals, via the data communication should the smoke detector/alarm 211 or carbon monoxide detector/alarm 221 go off, or should the thermostat/HVAC system 251 status be out of an acceptable range.

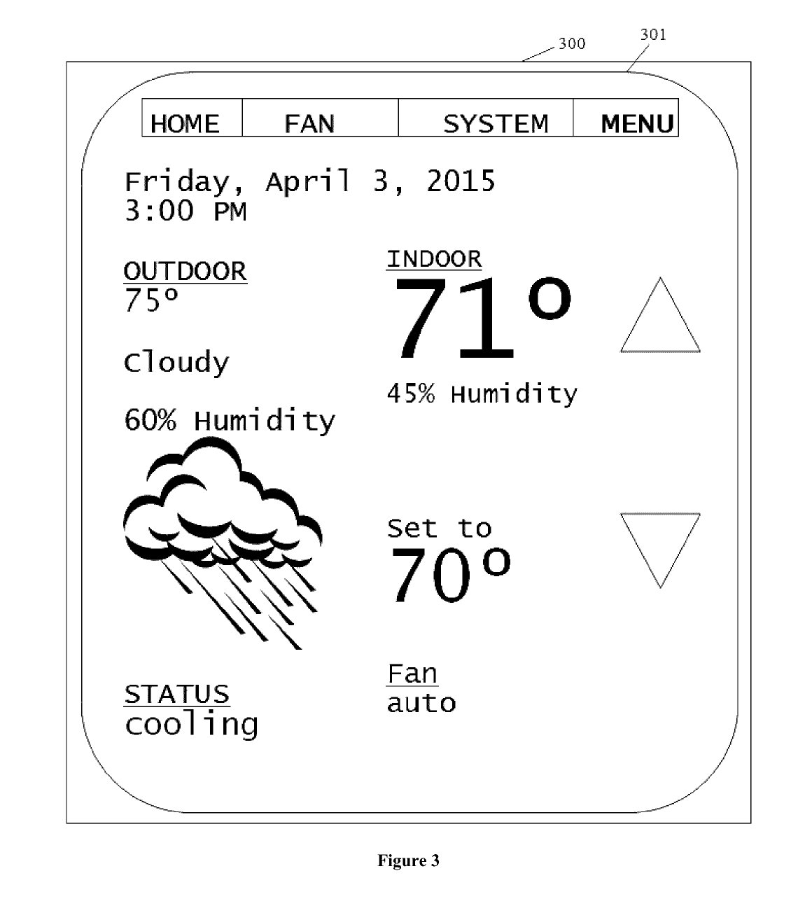

FIG. 3 shows an example of a care recipient interface 301 on a general electronic device 300 that is used to operate a first device, such as a thermostat. General electronic device 300 may be a mobile phone, tablet, or other handheld device, or a computer, programmed to display such care recipient interface 301. The programming may be done, for example, through a downloaded or installed software program or application. In this example interface, easy-to-read text is of a size and simplicity to enable the care recipient to easily know the date, time, outdoor and indoor conditions. In this example, it is 75 degrees outside, cloudy, with 60 percent humidity. However, indoors the temperature is currently 71 degrees and 45 percent humidity. The fan is set to auto(matically on), and since the care recipient has set the indoor temperature to be 70 degrees, the HVAC system is in a state of cooling down the indoors from 71 degrees, and the user interface displays this status as such. It is conceived that the care recipient may press on the up or down arrows to change the desired indoor temperature.

While a care recipient interface 301 presents control settings for a thermostat, it is contemplated that control settings for other household-type, electronically-controlled devices can be presented including, but not limited to a telephone, a television, and a radio/MP3 player/stereo/music service. Additionally, or alternatively, at least a portion of care recipient interface 301 can be remotely programmed by a caregiver using a caregiver interface to present a custom-selected image on care recipient interface 301 to facilitate the care recipient in operating the first device. For example, an image of an older model thermostat can be presented as care recipient interface 301 where the physical buttons of the older model thermostat are displayed as virtual buttons.

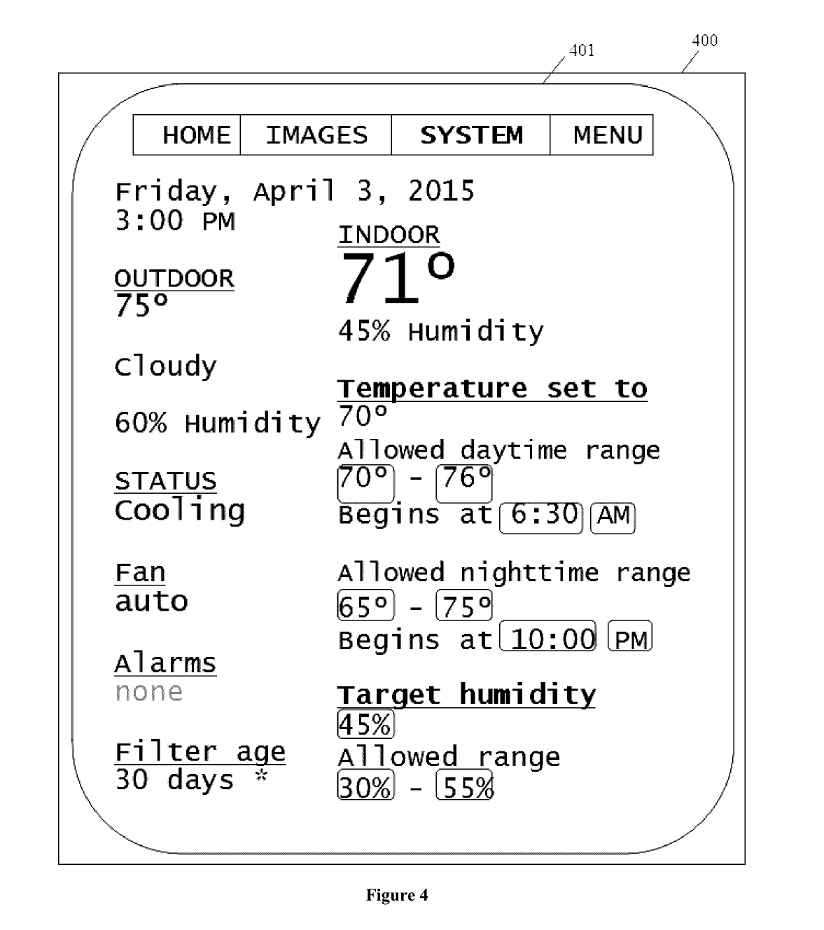

FIG. 4 shows an example of a caregiver interface 401 on a general electronic device 400. Although the format is similar to that in FIG. 3, significantly more information is displayed and controllable using caregiver interface 401. In the example shown, which could be what is presented to a caregiver when a care recipient uses the care recipient interface of FIG. 3, the same indoor and outdoor temperature, humidity, and fan setting information are displayed, as well as the date and time. However, the caregiver interface also incorporates the ability to easily adjust the allowed daytime range of the indoor temperature, the allowed nighttime range of the indoor temperature, and the times that daytime and nighttime are considered to begin. Thus, a caregiver can control a minimum and maximum temperature that the indoor temperature can be set to so that a temperature that is detrimental to the health of the care recipient is not entered.

Similarly, the caregiver may set an allowed range of humidity within the house, and a target, so that depending on the seasons, the outdoor weather conditions, and the health of the care recipient, more dry or more humid interior conditions may be maintained. Caregiver interface 401 also displays a visual indication of whether any alarms are currently active, and the age of the HVAC filter. Colors and symbols may be used to indicate that all systems are normal, or to provide a reminder, or a warning. For example, red may indicate a setting or issue that needs to be addressed, whereas green could signify that all systems are normal. Alternatively or additionally, an asterisk, triangle, or other symbol could signify an item that will be due for some maintenance soon. For example, if it is preferred to change a filter when it is between 30 and 60 days old, a symbol could appear to remind the caregiver to check the filter.

In some instances and for some care recipients, it may be desirable to display a familiar tactile interface to the care recipient that mimics the adjustment interface of a traditional appliance, while still facilitating control, limiting, and monitoring of the settings capabilities by a caregiver. For those instances, it is contemplated that a caregiver can select “IMAGES” on caregiver interface 401 to open a gallery of images from which a care recipient or the caregiver can select to remotely program at least a portion of care recipient interface (e.g., FIG. 3) to display. For example, a gallery of thermostats from different time eras can be presented on caregiver interface 401 and caregiver or care recipient can select the image of the thermostat that is most familiar to the care recipient, such that the familiar custom-selected image of the thermostat facilitates the care recipient to operate the thermostat via the care recipient interface. It is contemplated that the same principle applies to other devices that are controlled by a care recipient interface, such as a telephone, a television, and a radio/MP3 player/stereo/music service. In other embodiments, a specialized device having physical knobs may be particularly beneficial over a tablet or other screen-only computing device for those care recipients are having difficulties interacting with a purely digital display.

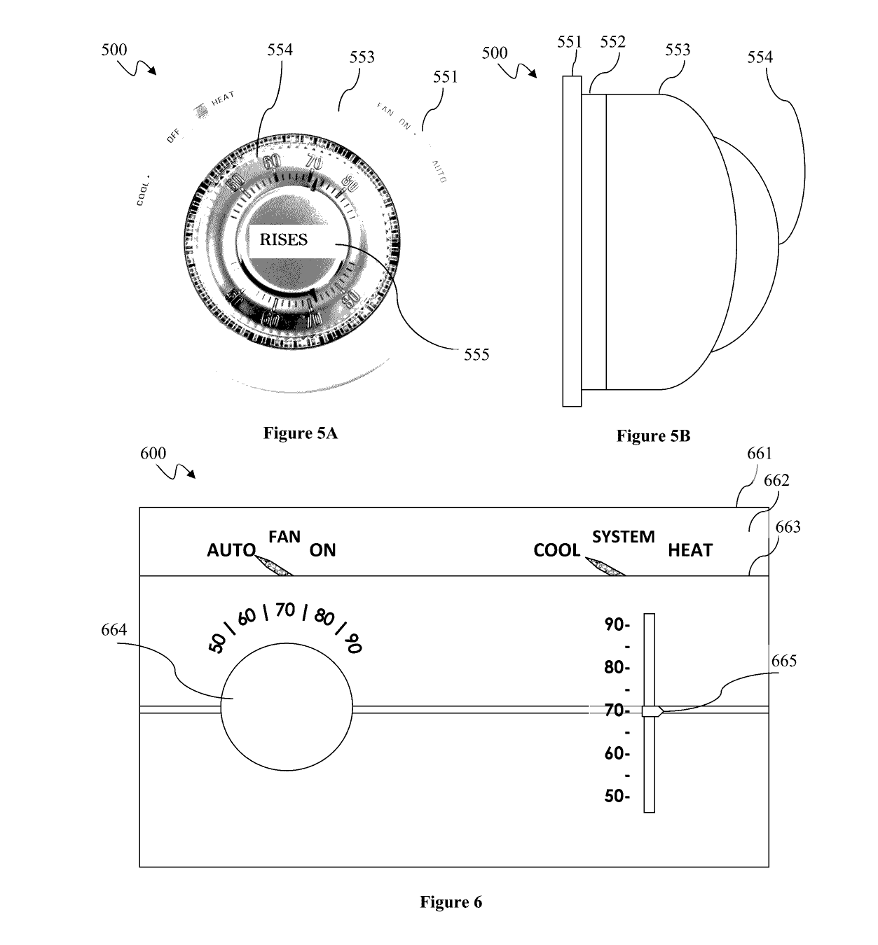

FIG. 5A shows an embodiment of a specialized device 500 having a thermostat-like control image and a mechanical knob. FIG. 5B is a side view of FIG. 5A. Accordingly, in one embodiment a specialized device, having an overall circular shape, comprises a backboard 551 which may or may not have a fixed appearance, upon which at least a screen 552 and a mechanical knob or dial 554 are configured. In the example shown, backboard 551 includes the text “COOL,” “OFF,” “HEAT,” and “ON” or “AUTO” relative to “FAN.” In such a manner backboard 551 provides the indicators most relevant to a traditional thermostat.

In some configurations the backboard 551 may also include physical levers to manually choose between the displayed indicators. In other configurations, the levers may be approximated digitally, via the screen 552 and displayed as an overlay on the backboard 551. In the example shown, the screen 552 is covered by a shell 553 which gives the specialized device the appearance and tactile sensation of a domed thermostat. Mechanical knob or dial 554 enables the care recipient to make adjustments to the temperature setting manually, as one would control an older-model thermostat. Knob or dial 554 may be patterned after the control dial of an older-model thermostat, or can be composed of a transparent material that allows an image on screen 552 to be projected onto knob or dial 554. It should be appreciated that the image displayed on screen 552 is remotely programmable by a caregiver using a caregiver interface.

If desired, an additional notification 555 may be displayed at the center of knob or dial 554, to easily inform the user that the device is in operation, e.g. via a light or a colored light to signify the status. In this manner, a care recipient may control the thermostat, system, or other device or appliance via an interface that is familiar to them, from previous use, while still gaining the benefits and oversight of the system and technology disclosed herein.

FIG. 6 shows another embodiment of a specialized device 600 having a thermostat-like control image and a knob. In an alternate embodiment, a specialized device is a generally polygonal shape, and comprises a backboard 661 which may or may not have a fixed appearance, upon which at least a screen 662 and a mechanical knob or dial 664 are configured. In the example shown, backboard 661 includes the text “COOL” and “HEAT” relative to “SYSTEM,” and “ON” or “AUTO” relative to “FAN.” In such a manner backboard 661 provides the indicators most relevant to a traditional thermostat.

In some configurations, backboard 661 may also include physical levers to manually choose between the displayed indicators. In other configurations, the levers may be approximated digitally, via the screen 662 and displayed as an overlay on the backboard 661. In the example shown, screen 662 is covered by a shell 663 which gives the specialized device the appearance and tactile sensation of a substantially-rectangular thermostat. It is contemplated that shell 663 can be a transparent material that allows an image on screen 662 to be projected onto shell 663. It should be appreciated that the image displayed on screen 662 is remotely programmable by a caregiver using a caregiver interface.

Mechanical knob or dial 664 enables the care recipient to make adjustments to the temperature setting manually, as one would control an older-model thermostat. Knob or dial 664 may be patterned after the control dial of an older-model thermostat, or be made very simple and rely in its display on the screen 662 portion that shows under it, through the shell 653. If desired, an additional notification may be displayed proximate to the knob or dial 664, to easily inform the user that the device is in operation, e.g. via a light or a colored light to signify the status, relative to the temperature chosen. For example, the arrow 665 could be red when the system is in heating mode, and green when the system is in cooling mode. In this manner, a care recipient may control the thermostat, system, or other device or appliance via an interface that is familiar to them, from previous use, while still gaining the benefits and oversight of the system and technology disclosed herein.

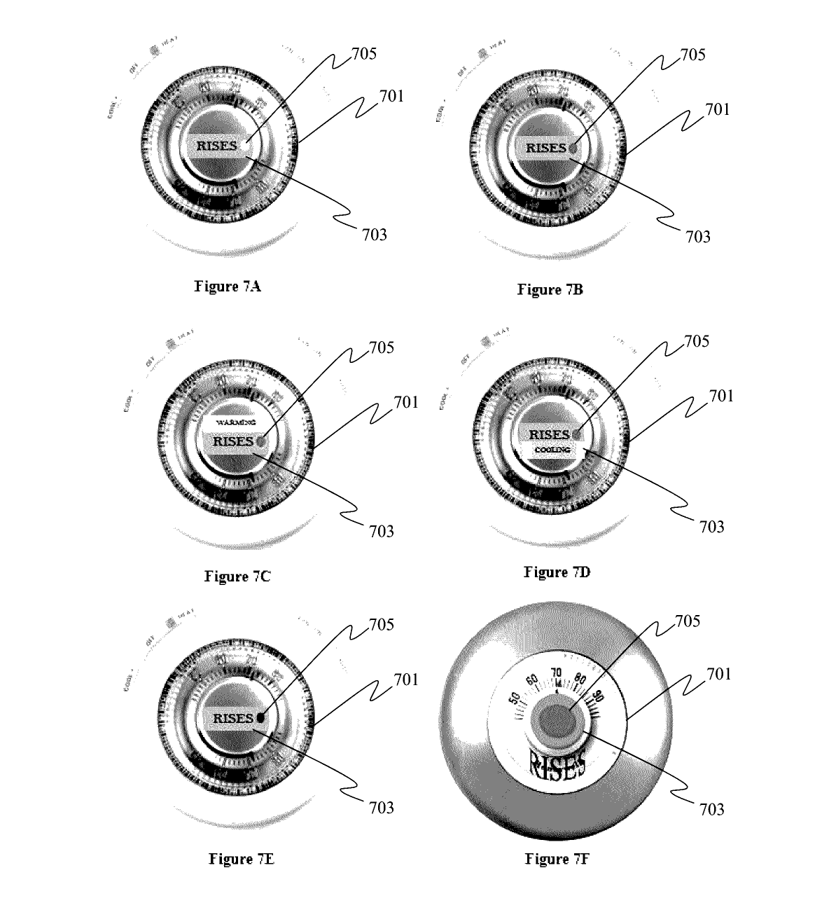

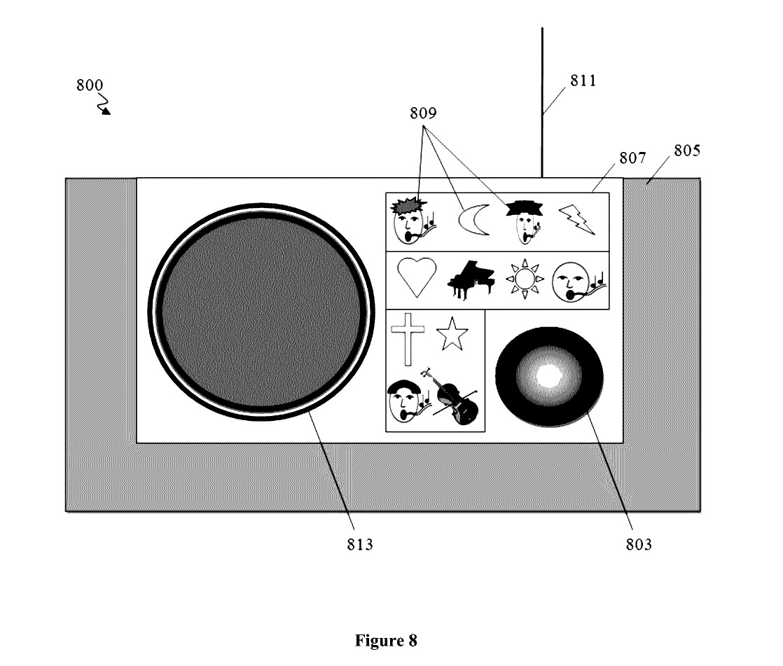

Examples of a care recipient interface on a thermostat-like care recipient device are shown in FIGS. 7A-7F. FIG. 7A shows an example of a thermostat-like control image on a specialized device with a knob 701 similar to that of FIGS. 5A and 5B, specifically in and off mode. In such a mode, indicator 705 on a notification area 703 does not indicate any particular color, and thus can signify to the care recipient that the device is not in operation. However, when as in FIG. 7B, showing the thermostat-like control image of FIG. 7A in an on mode, a care recipient can easily tell that the device is on and operable through the display of a green “on” indicator 705.

FIG. 7C shows the thermostat-like control image of FIG. 7A in a warming mode. Here, in addition to the green “on” indicator 705 in notification area 703, the text “WARMING” is displayed, along with a yellow background, above the usual notification area. Thus, both the use of color and/or position of the notification can signify to the user that the device is in a warming mode, and that the temperature has been programmed to rise, and that the ambient area should become warmer. Such an easy visual indicator can be very significant to a care recipient, who may quickly forget what they last set the system to, and whether or not they had desired to warm their room, and help to forestall any impatience or frustration from a system that often may take a little time to react to a change in the settings. Similarly, FIG. 7D shows the thermostat-like control image of FIG. 7A in a cooling mode. Here, notification area 703 displays the green “on” indicator 705, but also a blue “COOLING” bar in notification area 703 to indicate that the device is in a cooling mode and that the temperature has been programmed to decrease and that the area should become cooler.

FIG. 7E shows one way to indicate to the care recipient (and others) that the device needs service or some monitoring, through the use of a red light indicator 705 in the notification area 703. Such a notification could prompt the care recipient or other user to understand why the device might not be reacting as expected, and may prompt the user to contact a caregiver or other service person about the issue. In other configurations, the red light indicator 705 could also be an indicator that the setting chosen by the care recipient is not permitted, or that a power or communication source of the specialized device (e.g., a battery, Wi-Fi connection, Bluetooth connection, etc.) is low or unsatisfactory for the normal performance of the device, and that the device needs a new battery or reset of its connectivity. The caregiver or other user could also have configured the device to communicate such errors to the caregiver interface and/or its alarm functions so that the care recipient themselves does not have to notice/notify the caregiver of such issues. It should be appreciated that a caregiver can configure the device remotely using a caregiver interface.

FIG. 7F shows an alternate thermostat-like control image. In such an embodiment, a one or more or a combination of the backboard, display screen, shell, mechanical knob, or notification area can be different from that shown in FIG. 5A and 6A. The specific combination of the backboard, display screen, shell, mechanical knob 701, or notification area 703 can be chosen to optimally provide the care recipient with a familiar and useful interface. Thus, here the thermostat-like control image approximates a different model of a traditional thermostat interface, and uses different visual cues to interface with the care recipient. Similarly, the notification area 703 can be adjusted to be fully graphical and avoid the use of text, as is shown here, where an indicator 705 can be green to show that the unit is on, and a blue to show that the system is in a cooling mode. Other combinations, customizations, appearances, and interfaces are envisioned. A caregiver using a caregiver interface can remotely program the device to present this alternative thermostat-like control image from the thermostat-like control image of FIGS. 7A-7E. It is contemplated that a caregiver can also customize and control the device using a caregiver interface.

FIG. 8 shows a special radio device 800 having a physical knob 803. Special radio device 800 is a customized unit that can be remotely programmable by a care recipient interface. For example, it is contemplated that the special radio device 800 is an electronic device having a rectangular shape, which mimics an old-fashioned radio, and a care recipient interface 805. Special radio device 800 can be coupled to a first device that plays audio, such as an electronic radio, a digital music player (e.g., iPod®, Microsoft Zune®, Sony Walkman®, etc.), or a computer. However, in other embodiments, special radio device is a radio with a care recipient interface 805.

Care recipient interface 805 can be a touch screen display that receives a tactile input. Radios of different generations can be presented on care recipient interface 805, such that a user can interact with virtual knobs or buttons of those radios. As discussed above, a caregiver device having a caregiver interface can be used to remotely program care recipient interface 805 to display the various customized images, which facilitates the care recipient in operating special radio device 800.

Care recipient interface 805 can also comprise a physical knob 803 that allows a user to turn knob 803 to change at least one of a radio station, a music track, a playlist, an artist, or a genre of music. It is contemplated that special radio device 800 can have more than one physical knob and can comprise one or more physical buttons. Additionally, or alternatively, special radio device 800 comprises a display area 807 having at least one custom-selected image 809. While display area 807 comprises at least one custom-selected image, it is contemplated that the care recipient interface 805 displays one custom-selected image, which could be an image of an old fashioned radio.

Display area 807 can present at least one of time, weather, a music artist, a music track, a musical genre, a music playlist and an album title. As discussed above, display area 807 comprises at least one custom-selected image 809. It is contemplated that different display areas are disposed on care recipient interface 805, such that one display area can present at least one custom-selected image 809 while other display areas can present time, weather, a music artist, and other information relevant to a radio. However, it is also contemplated that display area 807 presents both at least one custom-selected image 809 and other radio information (e.g., time, weather, music artist, song title, etc.).

Custom-selected image 809 comprises custom-selected images of a musician or musical group, an icon suggestive of a genre, or perhaps an image of a building in a town with which the care recipient has particular memory association. It is contemplated that custom-selected image 809 is remotely programmed on care recipient interface 805 by a caregiver interface on a third device as described above. Additionally, or alternatively, knob 803 can be coupled to care recipient interface 805 to receive a physical interaction, such that rotating the knob changes custom-selected image 809 to a second custom-selected image. For example, custom-selected image 809 could be an image of a first musical artist (e.g., Frank Sinatra) and a second custom-selected image could be an image of a second musical artist (e.g., Dean Martin), such that rotating knob 803 can switch the first musical artist to the second musical artist, and vice versa, on care recipient interface 805.

It should be appreciated that a care recipient can operate special radio device 800, including any radio, digital music player, and other electronic music player coupled with special radio device 800, by a physical interaction with care recipient interface 805. For example, a user can touch custom-selected image 809 to play a song. It should be appreciated that custom-selected image 809 can be an image familiar to the user of a specific song or musical genre, such that custom-selected image 809 can be an image of Frank Sinatra, and Frank Sinatra music plays when user touches the custom-selected image 809. Additionally, user can scroll through various custom-selected image 809 using knob 803 until a desired one is encountered and user can touch custom-selected image 809 to make a selection. It is also contemplated that a user can operate special radio device 800, including any radio, digital music player, and other electronic music player coupled with special radio device 800, by an auditory interaction. In such embodiments, special radio device 800 comprises a microphone to receive the auditory interaction. For example, special radio device 800 can play a Dean Martin song after receiving a verbal request from a care recipient to play Dean Martin.

Special radio device 800 can include equipment that is typically found in a radio. For example, special radio device 800 comprises a speaker 813 and an antenna 811. Other equipment that is necessary to operate a radio can be housed within special radio device 800. Thus, special radio device 800 can be built as a standalone radio having care recipient interface 805, such that the first device and the second device are in a single unit. However, as discussed above, it is contemplated that special radio device 800 can be coupled to a first device, such as a radio, digital music player or a computer. In such embodiment, care recipient interface 805 on special radio device is used to operate the first device.

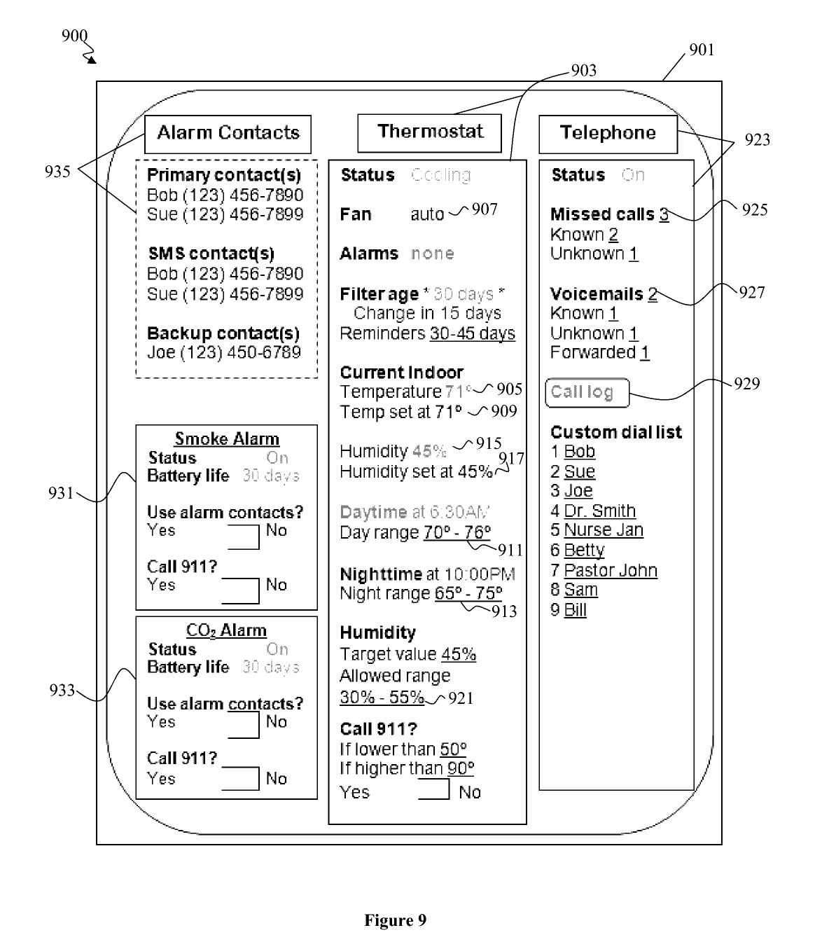

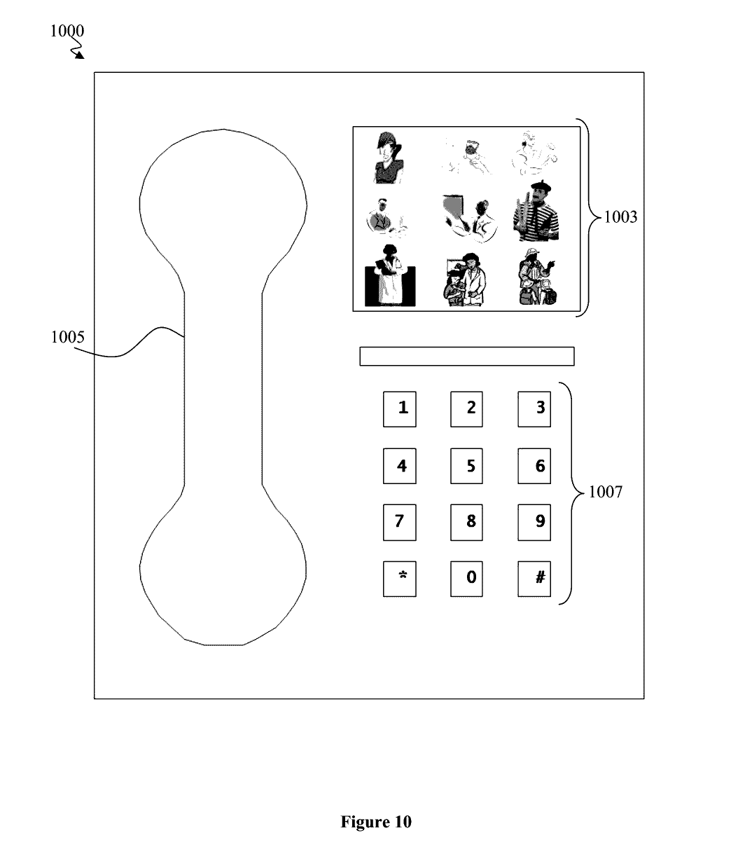

FIG. 9 shows an example caregiver interface 901 that is used to remotely program at least one of a first device and care recipient interface on a second device to limit and override care recipient controls and program alarm settings. Caregiver interface 901 is installed on a third device 900, such as a mobile device, a tablet, and a computer. As discussed above, caregiver interface 901 can remotely program the care recipient interface to present a custom-selected image that facilitates the care recipient to operate a first device.

Caregiver interface 901 allows a caregiver to perform various tasks related to the first and second devices. For example, caregiver interface 901 enables a user to operate a first device (e.g., telephone, thermostat, radio). Caregiver interface 901 can have a thermostat display area 903, which allows a user to operate a thermostat as the first device. Thermostat display area 903 presents (i) the status of the thermostat to show whether it is cooling, heating or off, (ii) the fan setting for the thermostat, and (iii) the filter age of the air filter. Reminders can be set or adjusted for the air filter by applying touching the current reminder setting to open a drop-down menu and selecting a new reminder setting. It is contemplated that a voice command, a physical knob, or some other physical or electronic interface can be used to set or modify the reminder setting.

Thermostat display area 903 comprises a current temperature 905 of a system that is being maintained near a desired temperature by the thermostat. Typically, care recipient enters this system, such as a bedroom, a patient room, a living room, and a bathroom. Thus, it is critical that a caregiver can monitor current temperature 905 to ensure that the care recipient is not exposed to dangerous or uncomfortable temperatures. If a pre-determined dangerous or uncomfortable temperature is reached, then thermostat display area 903 can present an alarm 907.

A caregiver can directly control a thermostat using thermostat display area 903 of caregiver interface 901. The caregiver can modify the temperature of the thermostat by thermostat temperature input 909, which could be used to input a default temperature for the thermostat device. It is contemplated that a user can touch thermostat temperature input 909 to modify the current temperature setting of the thermostat. The user can either select another temperature on a drop-down list, input a temperature using a virtual keyboard, give a voice command, or input the new temperature using other suitable means. It is contemplated that the temperature presented on the thermostat temperature input 909 is the current setting of the thermostat as set by a care recipient using a care recipient interface or by caregiver, and that the caregiver can override the setting to input a new temperature. Additionally, or alternatively, thermostat temperature input 909 can be used to override a current temperature of the thermostat that was set by a care recipient or other user using the thermostat directly.

Thermostat display area 903 can also be used to set limits on a setting of the thermostat. For example, it is contemplated that a user can set daytime and nighttime temperature ranges. A caregiver can modify a daytime range by using daytime temperature range input 911 by a physical interaction. For example, the caregiver can either touch daytime temperature range input 911 to access a drop-down list, a virtual keyboard, and other input devices to enter a temperature range. Likewise, a nighttime temperature range input 913 can be used to input a temperature range. It should be appreciated that the daytime and nighttime time settings can be modified as desired by a caregiver.

The daytime and nighttime temperature ranges can be used to set the upper limit and lower limit for automatic temperature control on the thermostat. However, daytime and nighttime temperature ranges can be used to restrict a care recipient interface to thermostat temperatures between a maximum and minimum temperature. If a care recipient using care recipient interface attempts to input a temperature above the maximum or below the minimum temperature set by the daytime and nighttime temperature ranges, then “ALERT” or the actual temperature entered by care recipient can be displayed on alarm 907. Additionally, or alternatively, an alert can be generated if current temperature 905 is outside the range of the maximum and minimum temperature, such as an automated phone call or text to caregiver or some other pre-set user.

It is contemplated that thermostat display area 903 can be used to view the status of and control humidity conditions. A current humidity level 915 can be displayed by thermostat display area 903. Additionally, a humidity level input 917 presents the current setting of the humidity level. Humidity level input 917 can be used to override a current setting of the humidity level using the same process described in adjusting temperature with thermostat temperature input 909. Similarly, thermostat display area 903 can have a humidity range input 921 to enter an allowable humidity range. Furthermore, it is contemplated that humidity range input 921 can be used to restrict a care recipient using a care recipient interface to entering humidity levels between a maximum and minimum humidity level.

Thermostat display area 903 can allow caregiver to set automatic calls to emergency services (e.g., 911) if the current system temperature of the system is above or below a pre-determined temperature. It should be appreciated that the burden of calling emergency services is eliminated from the care recipient. Thus, emergency services will automatically be contacted if there is a thermostat failure and the current temperature exceeds or falls below a pre-determined temperature.

It is contemplated that caregiver interface 901 only presents thermostat display area 903, which enables caregiver to at least one of operate the thermostat and remotely program care recipient interface. Alternatively, caregiver interface 901 can further present a telephone display area 923. A caregiver can use telephone display area 923 to operate a telephone and remotely program a care recipient interface that a care recipient can use to operate the telephone. It is contemplated that telephone display area 923 shows a status (e.g., on, off, off the hook, etc.) of the telephone. Telephone display area 923 can also present the number of missed calls and voicemails, and whether the call was made by a known or unknown phone number. Caregiver can access the specific phone numbers of the missed calls and voicemails by a physical interaction (e.g., push) on either the missed call icon 925 or the voicemail icon 927 on the telephone display area 923. The specific known phone numbers or unknown phone numbers can be viewed by selecting the appropriate icons adjacent to such fields. To present all calls to the telephone, caregiver can select a call log icon 929.

Telephone display area 923 can include a custom dial list that allows caregiver to remotely program telephone numbers onto a care recipient interface. It is contemplated that caregiver can remotely program the care recipient interface to present a custom-selected image of a person that is associated that a telephone number. The custom-selected image can be selected from a catalogue of images or can be uploaded by caregiver.

Caregiver interface 901 can further comprise a smoke alarm display 931 and a carbon monoxide (CO) alarm display 933. Smoke alarm display 931 and CO alarm display 933 present the status of each unit (e.g., on, off, smoke detected, CO detected) and battery life (e.g., 30 days, 15 days, low battery—attention needed). Alarm contacts can be designated with each of the smoke alarm and CO alarm using an alarm contacts display 935. The alarm contacts can be edited by caregiver by touching alarm contact display 935 to open a menu that allows caregiver to enter contact information for an alarm contact. It should be appreciated that the alarm contact can be reached using a number of various communication channels, such as a phone, internet, Bluetooth, and WiFi. It is contemplated that primary contacts, SMS contacts, and backup contacts can be programmed. Additionally, or alternatively, smoke alarm display 931 and CO alarm display 933 can be used to toggle alarm contacts on or off. This can be performed by sliding an icon in either smoke alarm display 931 or CO alarm display 933 from yes to no or no to yes. In other embodiments, a physical button or knob can be used to turn alarm contacts on or off. Similar to the thermostat display 903, smoke alarm display 931 and CO alarm display 933 can have an option to call an emergency response service, which could be toggled on or off.

FIG. 10 shows an example phone interface 1000 for a care recipient, in which a caregiver has incorporated custom-selected images 1003. It is contemplated phone interface 1000 is the care recipient interface that is installed on a second device (e.g., mobile phone, tablet, computer, etc.) that care recipient can use to operate a first device (e.g., phone). In such embodiment, care recipient interface can be a touch-screen display. In other embodiments, the phone interface 1000 can be part of a special telephone device that comprises typical components of a telephone or other communication device (e.g., internet telephone) such that calls can be made using the special telephone device. In such instance, phone interface 1000 facilitates the care recipient to operate the device on which phone interface 1000 is installed.

Phone interface 1000 can be configured to operate the first device by receiving a physical interaction. For example, a care recipient can touch an image of custom-selected images 1003 to place a call to the person associated with that image. In another example, a care recipient can pick up a handset 1005 and dial a phone number by pushing buttons 1007. While a physical handset 1005 and buttons 1007 are contemplated, it should be appreciated handset 1005 and buttons 1007 could be digital. In such embodiment, the handset is displayed for purposes of mimicking a phone interface.

Phone interface 1000 can be configured to operate the first device by receiving an auditory interaction, such as voice command. Such contemplated embodiments would include a microphone suitable to receive a voice command. For example, a care recipient can state a name of a person that a microphone on phone interface 1000 receives to operate the phone to call that person.

Custom-selected images 1003 can be remotely programmed on phone interface 1000 using a caregiver interface. A plurality of images can be displayed on at least one of a caregiver interface and care recipient interface (e.g., phone interface 1000) to allow the care recipient to select images for custom-selected images 1003. When the care recipient has a cognitive impairment (e.g., Alzheimer's disease), it is contemplated that the care recipient will select the most recognizable image of the person as a custom-selected image 1003. The caregiver can also remotely program phone interface 1000 to change one custom-selected image 1003 to a second custom-selected image from the plurality of images. Additionally, or alternatively, phone interface 1000 can include a physical knob or tab that is configured to allow the care recipient to scroll through the custom-selected images 1003.

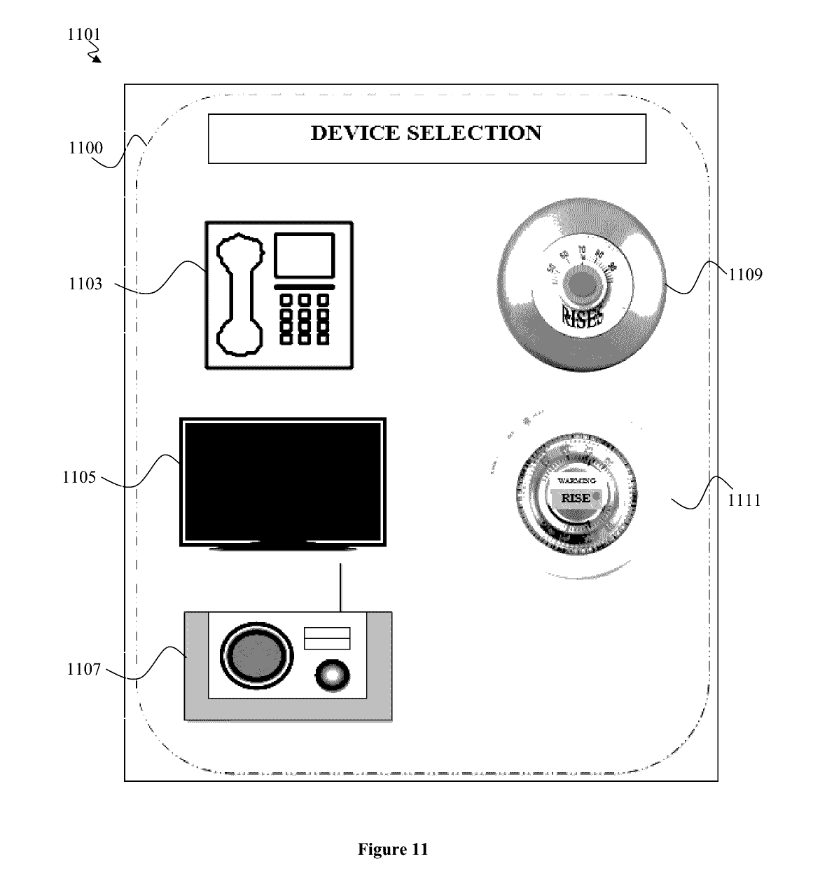

FIG. 11 shows an example appliance selection user interface 1100 for a care recipient. Appliance selection user interface 1100 can be installed on a second device 1101 that a care recipient can use to operate a plurality of devices. Contemplated devices include a telephone, television, radio, smoke alarm, CO alarm, and thermostat. Furthermore, suitable second devices include a mobile device, a tablet, and a computer.

User interface 1100 can be a touch screen display that enables care recipient to select a device by touching appliance selection user interface 1100. Care recipient can select a telephone icon 1103, television icon 1105, a radio icon 1107, a first thermostat icon 1109, and a second thermostat icon 1111. Other suitable devices that can be presented on appliance selection user interface 1100 include a smoke alarm, a CO alarm, and other devices that can be configured to be electronically controlled. Care recipient can operate each of the devices from appliance selection user interface 1100 by applying a physical interaction to the various icons. For example, care recipient can rotate first thermostat icon 1109 on appliance selection user interface 1100 to increase or decrease a set temperature. Additionally, or alternatively, appliance selection user interface 1100 can be used to access an interface that enable the care recipient to operate the device. For example, a care recipient can touch telephone icon 1103 to display a telephone interface, such as that shown in FIG. 9.

It should be appreciated that each of the device icons can be remotely programmed by a caregiver interface to present a custom-selected image associated with the device. Thus, a care recipient can better recognize the device that he or she chooses to operate by using a custom-selected image. For example, radio icon 1107 can be remotely programmed to display a modern radio or music player (e.g., an iPod®) or an old-fashioned radio.

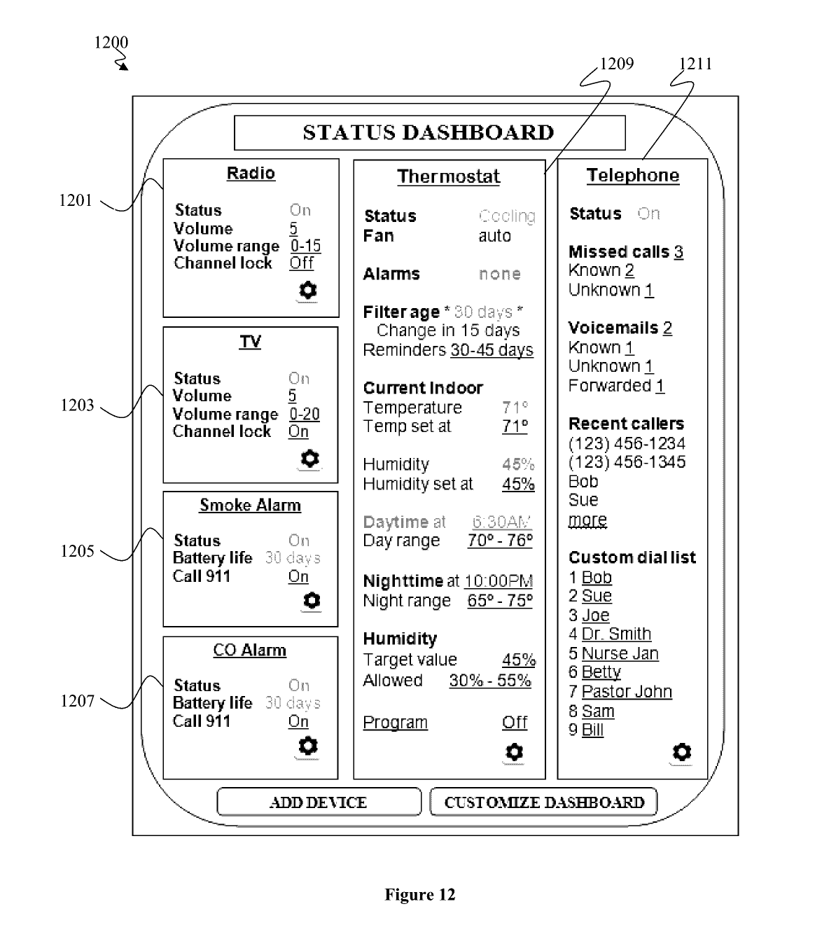

FIG. 12 shows an example care recipient status interface 1200 for a caregiver to monitor a care recipient. It is contemplated that status interface 1200 is installed on a third device. Caregiver can use status interface 1200 on the third device to remotely program a care recipient interface on a second device. The care recipient interface can be used by a care recipient to operate at least one of a first device and the second device.

Status interface 1200 has display areas to monitor various first devices. For example, a caregiver can monitor a radio, a television a smoke alarm, a carbon monoxide alarm, a thermostat and a telephone using status interface 1200. Radio display area 1201 presents the status of the radio, current volume setting, volume range, and a channel lock. It is contemplated that a caregiver can modify each of these settings by selecting the setting via touch or some other tactile input or via an auditory interaction.

Television display area 1203 similarly presents the status of the television, current volume setting, volume range, and channel lock. It is contemplated that a caregiver can modify any of these settings by selecting one these features and modifying the entry to the desired setting. For example, caregiver can select volume on the television display area 1203 and change the current volume of the television from five to some other number.

Smoke alarm display area 1205 and carbon monoxide display area 1207 present the status, battery life, and an emergency dial setting. A caregiver can modify each of these settings using smoke alarm display area 1205 or carbon monoxide display area 1207 by selecting a setting and modifying the number on the smoke alarm display area 1205 or carbon monoxide display area 1207.

Thermostat display area 1209 is similar to the thermostat display area disclosed in FIG. 8. Thermostat display area 1209 presents the status of the thermostat, fan settings, alarms, filter age, and other settings. Current indoor temperature and humidity temperatures are presented and can be modified by selecting one of the settings and selecting a new setting on thermostat display area 1209. For example, caregiver can select “Temp set at 71°” and input 74° to modify the temperature settings of the thermostat. Thus, it is contemplated that thermostat display area 1209 can be used to directly operate the thermostat. In another example, caregiver can select daytime range 70°-76° and input a new range between 72° to 74° to limit the temperatures that a care recipient can set for the thermostat via a care recipient interface. Thus, it is further contemplated that thermostat display area 1209 can be used to remotely program a care recipient interface on another device.

Telephone display area 1211 presents the status of the telephone along with other information related to the incoming calls to the telephone. As described in FIG. 8, a caregiver can monitor the call log of the telephone, which includes recent callers, missed calls and voicemails. In addition, caregiver can remotely program a custom dial list on a care recipient interface for the telephone. It should be appreciated that each number on the list can include a remotely programmable custom-selected image that is associated with the number. Such remotely programmable custom-selected image is selected by the care recipient or caregiver and is remotely programmed from care recipient status interface 1200 on a third device to a care recipient interface on a first device.

Additional devices can be added on care recipient status interface 1200 by selecting the add device icon. In addition, care recipient status interface 1200 can be customized to move to adjust the location of the various display areas or to present only some display areas. It should be appreciated that a custom-selected image can be remotely programmable to a care recipient interface to operate a device on care recipient status interface 1200. For example, caregiver can select a widget icon on telephone display area 1211 to load a plurality of images and care recipient or caregiver can select one of the images as the custom-selected image to remotely program onto a care recipient interface. Preferably, the caregiver interface and care recipient are installed on separate devices.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The description includes information that may be useful in understanding the presently disclosed subject matter. It is not an admission that any of the information provided herein is prior art or relevant to the presently claimed subject matter, or that any publication specifically or implicitly referenced is prior art.

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

1. A method of assisting a care recipient in operating a first device, comprising:
providing a care recipient interface configured to be installed on a second device other than the first device, such that the care recipient can operate the first device through the care recipient interface on the second device; and
providing a caregiver interface configured to be installed on a third device to monitor the first device and the second device, and provide both (a) direct control of the first device and (b) indirect control of the first device through the care recipient interface, wherein the caregiver interface is configurable to remotely program the care recipient interface to present a custom-selected image, which the care recipient can use to cause the first device to execute a selected function.

2. The method of claim 1, wherein the care recipient interface is configured to operate the first device by receiving at least one of a physical interaction and an auditory interaction.

3. (canceled)

4. The method of claim 1, wherein the care recipient interface is configured to operate at least one of a phone, a thermostat, a radio, a TV, and a smoke alarm as the first device.

5. The method of claim 1, wherein the care recipient interface is installed on at least one of a mobile device, a tablet, and a computer as the second device.

6. The method of claim 1, wherein the care recipient interface is configured to operate the first device via rotating a knob.

7. The method of claim 1, wherein the caregiver interface enables the caregiver to remotely program the care recipient interface to at least one of (i) operate the first device, (ii) override a current setting for the first device, and (iii) receive alerts based on the current setting of the first device.

8. The method of claim 1, wherein the caregiver interface enables the caregiver to remotely program the care recipient interface to at least one of (i) set a default setting for the first device, (ii) set a limit on a setting of the first device, and (iii) receive alerts when the limit is exceeded.

9. The method of claim 1, further comprising providing a plurality of different images of the first device, wherein the custom-selected image is obtained from the plurality of different images, and wherein the caregiver interface is configured to allow the caregiver to remotely change the custom-selected image to a second custom-selected image of the plurality of different images.

10. The method of claim 1, wherein the custom-selected image mimics an interface of an older model of the first device that is familiar to the care recipient.

11. The method of claim 1, wherein the care recipient interface enables the care recipient to operate a phone as the first device, and the caregiver interface enables the caregiver to present an image of a person as the custom-selected image on the care recipient interface, such that a physical interaction with the custom-selected image will operate the phone to make a phone call.

12. The method of claim 1, wherein the care recipient interface enables the care recipient to operate a thermostat as the first device, and the caregiver interface enables the caregiver to present an image of a thermostat as the custom-selected image on the care recipient interface.

13. The method of claim 12, further comprising providing a knob that is coupled to the care recipient interface to receive a physical interaction, such that rotating the knob modifies the thermostat to increase or decrease a temperature.

14. The method of claim 1, wherein the care recipient interface enables the care recipient to operate a radio as the first device, and the caregiver interface enables the caregiver to present an image of at least one of a radio and a music artist as the custom-selected image.

15. The method of claim 14, further comprising providing a knob that is coupled to the care recipient interface to receive a physical interaction, such that rotating the knob changes the custom-selected image to a second custom-selected image.

16. A method of assisting a care recipient in operating a first device, comprising:
providing a catalogue of different images that visually depict controls for the first device;
providing a care recipient interface that enables operation of the first device through the care recipient interface, wherein the care recipient interface is installed on a second device other than the first device; and
providing a caregiver interface configured to monitor the first device and the second device, and provide both (a) direct control of the first device and (b) indirect control of the first device through the care recipient interface, wherein the caregiver interface enables remote programming of the care recipient interface to (i) present a custom-selected image from the catalogue of different images and (ii) modify the custom-selected image to a second custom-selected image from the catalogue of different images, wherein the care recipient can use the custom-selected image and the second custom-selected image to cause the first device to execute a selected function.

17. The method of claim 16, wherein the catalogue of different images is displayed on at least one of the care recipient interface and the caregiver interface, such that the care recipient can select one image of the catalogue of different images as the custom-selected image.

18. The method of claim 16, wherein the caregiver interface is installed on a third device and further wherein the caregiver interface enables remote programming of the care recipient interface to at least one of (i) operate the first device, (ii) override a setting of the first device, and (iii) receive alerts based on a setting of the first device.

19. The method of claim 16, wherein the care recipient interface enables operation of the first device by a physical interaction with at least one of the custom-selected image and the second custom-selected image.

20. The method of claim 16, wherein the caregiver interface enables remote programming of the care recipient interface to at least one of (i) set a default setting for the first device, (ii) set a limit on a setting of the first device, and (iii) send and receive alerts when the limit is exceeded.

21. The method of claim 16, wherein the first custom-selected image comprises an interface of a first model of the first device, and the second custom-selected image comprises a second interface of a second model of the first device, and wherein the first model and the second model are different.
